(19) United States
(12) Patent Application Publication
(10) Pub. No.: US 2015/0337072 A1
(43) Pub. Date: Nov. 26, 2015

(54) USE OF TIN SALTS OF NEODECANOIC ACID IN THE PRODUCTION OF POLYURETHANE SYSTEMS

(71) Applicants: Thomas GÜNTHER, Neuss (DE); Sarah SCHMITZ, Duisburg (DE); Roland HUBEL, Essen (DE); EVONIK DEGUSSA GMBH, Essen (DE)

(72) Inventors: Sarah SCHMITZ, Duisburg (DE); Thomas GUENTHER, Neuss (DE); Roland HUBEL, Essen (DE)

(73) Assignee: EVONIK DEGUSSA GMBH, Essen (DE)

(21) Appl. No.: 14/758,999

(22) PCT Filed: Jan. 3, 2014
(86) PCT No.: PCT/EP2014/050041

§ 371 Date: Jul. 2, 2015

(30) Foreign Application Priority Data
Jan. 4, 2013 (EP) 13150254.4

(51) Int. Cl. C08G 18/24; C08G 18/76; C08G 18/08; C08G 18/48

(52) U.S. Cl. CPC C08G 18/244; C08G 18/48; C08G 18/7621; C08G 18/14; C08G 2101/0083

(57) ABSTRACT

The invention relates to a catalyst system suitable for catalysis of the production of polyurethane systems, which is characterized in that the catalyst system contains a tin salt of neodecanoic acid.

The invention relates to the use of tin salt of neodecanoic acid and solutions thereof in coatings and paints, adhesion promoters, sealants and elastomers, and in the production of polyurethane systems (PUR systems).

Polyurethane systems include, for example, polyurethane coatings, polyurethane adhesives, polyurethane sealants, polyurethane elastomers or polyurethane foams.

Polyurethane foams have outstanding mechanical and physical properties and so are used in a very wide variety of fields. The automotive and furniture industries are a particularly important market for various PU foams, such as conventional flexible foams based on ether and ester polyols, cold-cure foams (frequently also referred to as HR foams), rigid foams, integral foams and microcellular foams and also foams with properties between these classifications, for example semi-rigid systems. For instance, rigid foams are used as inner roof liner, ester foams as interior door trim and also for die-cut sun visors, cold-cure and flexible foams are used for seat systems and mattresses.

Catalysts suitable for one-component moisture-reactive polyurethane compositions usually comprise tin compounds, such as tin carboxylates, especially tin octoate (which corresponds to tin 2-ethylhexanoate), frequently combined with tertiary amines.

Thus, the use of tin octoate in the manufacture of flexible PU foams based on polyetherols is described, for example, in Steve Lee, Huntsman Polyurethanes, The Polyurethanes Book, Wiley publishers, p. 140, 143-144, and Ron Herrington, Flexible Polyurethane Foams, Dow Chemical, p. 2.30. The tin octoate serves as catalyst for the reaction of isocyanates with polyols (it is also known as a gelling catalyst) via a complex transition state. During foaming, the tin octoate is hydrolysed and releases not only the salt of 2-ethylhexanoic acid but also the acid itself. This decomposition is desirable because it prevents the reverse reaction of the urethane bond to give the starting materials, but it should ideally not lead to the release of substances of potential toxicological concern. The patent literature also includes numerous applications which describe the use of said tin octoate, as, for example, in BE 779607, GB 1432281, GB 1422056, GB 1382538, GB 1012653, GB 982280. In these documents, preferred catalyst systems used are those which include tin octoate.

However, tin catalysts of this kind have recently been subject to ever greater pressure on the part of users owing to toxicological concerns with regard to the reactants used for preparation thereof, especially the ligands. There is therefore an increasing demand for toxicologically safe alternatives.

To help the automotive and furniture industries, and their foam suppliers, meet the increasingly tougher emission and toxicity requirements of recent years, catalyst systems have already been developed on the basis of less toxic ligands which become part of the foam structure by polymerization. Systems of this kind are described, for example, in EP 1013704. The disadvantage of these systems is thus the high use amounts thereof and the associated costs resulting from the low tin content and the significant shielding of the active tin by the ligands. These systems were hitherto one of the few alternatives to the widely used tin octoate catalyst system (tin(II) salt of 2-ethylhexanoic acid) or organotin compounds, such as dibutyltin dilaurate. The latter systems are a matter of concern with regard to the toxicity of the substances emitted. 2-Ethylhexanoic acid, emitted during and after foaming for example, represents a possible (teratogenic) risk of harm to the unborn child (R 63).

EP 2 289 960 describes the use of tin salts of branched carboxylic acids which do not have exclusively a single ethyl or n-propyl branch. The use of the salts of these acids had the advantage that it was possible to distinctly reduce emissions of the acid component. The resultant foams featured a high open cell content compared to tin octoate and tin propylheptanoate.

The problem addressed by the present invention was that of providing a catalyst system which is suitable for production of closed-cell foams and does not have one or more of the aforementioned disadvantages.

It has now been found that, surprisingly, catalyst systems according to Claim 1 solve this problem.

The present invention therefore provides catalyst systems suitable for catalysis of the production of polyurethane systems, which are characterized in that the catalyst systems contain at least one tin salt of neodecanoic acid. The present invention likewise provides for the use of such catalyst systems in the production of polyurethane systems, and corresponding polyurethane systems, especially polyurethane foams, and the use thereof.

The catalyst system according to the invention has the advantage that, even with a comparable molar amount based on tin in the tin salt (compared, for example, to tin octoate or tin isononanoate), foams having a significantly greater level of closed cells can be produced.

A further advantage is that, for the production of open-cell foams of comparable density, a distinctly smaller amount of tin salt is needed than in the case of use of tin isononanoate or tin octanoate catalysts known from the prior art. This advantage could be caused by another advantage of tin neodecanoate, namely the surprisingly high activity compared to tin isononanoate and tin octanoate at relatively low tin content.

The catalyst system according to the invention can be used for producing not only flexible foams based on ether and ester polyols but also rigid foams and also foams with properties between these two classifications, for example semi-rigid foams. A particular advantageous use is in the production of closed-cell foams, especially of those foams which are air- and watertight. In order to test these properties, it is possible, for example, to employ the GM test (General Motors Engineering Standard GM 6086M) or Ford test (Ford Laboratory Test Method BO-112 03). Both test methods are described in detail in patent U.S. Pat. No. 6,747,068 B2 (example 61). “Watertight” is understood in the context of the present invention to mean that the foam on 50% compression holds a 25 mm water column for 90 minutes without penetration of water (determined according to GM test as specified in U.S. Pat. No. 6,747,068 B2, example 61 B). In the examples, this GM test is employed for studying the foam properties.

The catalyst systems according to the invention, the process for producing the polyurethane foams and also the polyurethane foams themselves are hereinbelow described by way of example without any intention to limit the invention to these exemplary embodiments. Where reference is made in what follows to ranges, general formulae or classes of compounds, these shall encompass not just the corresponding ranges or groups of compounds explicitly mentioned, but also all sub-ranges and sub-groups of compounds which are obtainable by extraction of individual values (ranges) or compounds. Where documents are cited in the context of the present description, the content thereof shall fully form part of the disclosure content of the present invention particularly in respect of the substantive matter in the context for which the document was cited.

It is a feature of the catalyst system according to the invention which is suitable for catalysis of the production of polyurethane foams that it contains a tin salt of neodecanoic acid, preferably the tin(II) salt of neodecanoic acid.

Catalyst systems preferred in accordance with the invention are those which do not include any further tin salts and/or tin compounds.

The catalyst system may comprise exclusively the tin salt or the tin salt in combination with a solvent, for example water or one or more organic solvents. Preferably, the tin salt is used individually (in undissolved form). If the tin salt is used in dissolved form or in combination with a solvent, the catalyst system preferably contains an organic aprotic solvent. If the catalyst system contains an organic solvent, it is preferably selected from glycols, preferably monoethylene glycol (MEG or EG), propane-1,3-diol (PDO), butane-1,4-diol (BDO), diethylene glycol (DEG), propylene glycol (PG or PEG), dipropylene glycol (DPG), triethylene glycol, butyldiglycol (BDG), neopentyl glycol or 2-methylpropane-1,3-diol, polyols, preferably polyester polyols, polyether polyols, natural oil-based polyols (NOPs) or glycerol, esters, preferably fatty acid esters, more preferably isopropyl myristate, mineral oils, hydrocarbons, preferably mineral oils, hexane, pentane, heptane, decane or mixtures of saturated hydrocarbons, for example Kaydol products from Sonnebom, polyethers, preferably those which have a proportion of propylene oxide units of more than 20 mol %, based on the alkylene oxide units in the polyether, polyesters, preferably polycarbonates, phthalates, preferably dibutyl phthalate (DBP), dioctyl phthalate (DNOP), diethylhexyl phthalate (DEHP), diisononyl phthalate (DINP), dimethyl phthalate (DMP), diethyl phthalate (DEP), cyclohexanoates, preferably diisononyl cyclohexanoate (DINCH), end-capped polyethers, preferably dialkyl polyethers having, as alkyl radicals, butylmethyl, methylmethyl or butylbutyl radicals, preferably those obtainable from diol-started polyethers, olefins, lactams and lactones. If the tin salt is used in dissolved form or in combination with a solvent, the mass ratio of tin salt to solvent is preferably from 100:1 to 1:2, more preferably from 50:1 to 1:1 and especially preferably from 25:1 to 2:1.

As well as the tin salt(s) and one or more solvents, the catalyst system may include further components, for example one or more tertiary amines, one or more silicone stabilizers and optionally one or more emulsifiers. However, it is preferably in separate or dissolved form.

The catalyst system according to the invention can be used for production of any polyurethane systems. More particularly, the catalyst system according to the invention is used in the process according to the invention for production of polyurethane systems.

It is a feature of the process according to the invention for producing polyurethane systems that a catalyst system according to the invention is used. The process according to the invention is preferably used for production of polyurethane coatings, polyurethane adhesives, polyurethane sealants, polyurethane elastomers or polyurethane foams, preferably for production of polyurethane foams. The catalyst system according to the invention can be added to the reaction mixture preferably before or during the reaction, preferably with the aid of a mixing head.

As described, the catalyst system may include further constituents, for example water, tertiary amine, silicone stabilizer and optionally emulsifier. Such a solution of the catalyst is frequently referred to as activator solution. Preferably, however, the catalyst system is added separately.

In the process according to the invention, preference is given to the direct metered addition of a catalyst system comprising exclusively the tin salt(s). If this is not possible because this tin salt has too high a viscosity or is a solid, the tin salts are metered in directly in the form of a solution.

As an alternative to direct foaming, the catalyst system can also be metered in in dilute form. Anhydrous solutions are preferable here, since tin salts have only limited stability to hydrolysis.

The catalyst systems according to the invention are usable as catalysts in the standard formulations for production of polyurethane systems, especially polyurethane foams, comprising or preferably consisting of one or more organic isocyanates having two or more isocyanate-reactive groups, one or more polyols having two or more isocyanate-reactive groups, optionally further catalysts for the isocyanate-polyol and/or isocyanate-water reactions and/or the trimerization of isocyanate, water, optionally physical blowing agents, optionally flame retardants and optionally further additives.

Suitable isocyanates for the purposes of this invention preferably include any polyfunctional organic isocyanates, for example 4,4″-diphenylmethane diisocyanate (MDI), toluene diisocyanate (TDI), hexamethylene diisocyanate (HMDI) and isophorone diisocyanate (IPDI). The mixture of MDI and more highly condensed analogues having an average functionality of 2 to 4 which is known as crude MDI (“polymeric MDI”) is particularly suitable, as well as the various isomers of TDI in pure form or as isomeric mixture.

Polyols suitable for the purposes of the present invention are preferably all organic substances having a plurality of isocyanate-reactive groups, and also preparations thereof. All polyether polyols and polyester polyols typically used for production of polyurethane systems, especially polyurethane foams, are preferred polyols. Polyether polyols are obtained by reacting polyfunctional alcohols or amines with alkylene oxides. Polyester polyols are based on esters of polybasic carboxylic acids (which may be either aliphatic, as in the case of adipic acid for example, or aromatic, as in the case of phthalic acid or terephthalic acid, for example) with polyhydric alcohols (usually glycols). Natural oil based polyols (NOPs) can also be used. These polyols are obtained from natural oils such as soya or palm oil for example and can be used in the modified or unmodified state.

A suitable ratio of isocyanate to polyol, expressed as the index of the formulation, is preferably in the range from 10 to 1000, preferably from 40 to 350. This index describes the ratio of isocyanate actually used to calculated isocyanate (for a stoichiometric reaction with polyol). An index of 100 represents a molar ratio of 1:1 for the reactive groups.

Suitable further catalysts for the purposes of this invention are substances catalysing the gel reaction (isocyanate-polyol), the blowing reaction (isocyanate-water) or the di- or trimerization of the isocyanate. Typical examples are amines, e.g. triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl) ether, bismuth compounds or salts and potassium salts such as potassium acetate. It is preferable for further catalysts used to contain no tin compounds, especially no dibutyltin dilaurate.

The amounts in which the further catalysts are suitably used depend on the type of catalyst and typically range from 0.01 to 5 pphp (=parts by weight based on 100 parts by weight of polyol) or from 0.1 to 10 pphp in the case of potassium salts.

In the process according to the invention, the amount of tin neodecanoate used is preferably from 0.02 to 1 pphp, more preferably 0.04 to 1 pphp, especially preferably from 0.08 to 0.9 pphp and especially preferably 0.09 to 0.7 pphp.

Suitable water contents for the purposes of this invention depend on whether or not physical blowing agents are used in addition to the water. In the case of purely water-blown foams, the water contents typically range from 1 to 20 pphp; when other blowing agents are used in addition, the amount of water used typically decreases to 0 or to the range from 0.1 to 5 pphp. To achieve high foam densities, neither water nor any other blowing agent is used.

Suitable physical blowing agents for the purposes of this invention are gases, for example liquefied CO₂, and volatile liquids, for example hydrocarbons of 4 or 5 carbon atoms, preferably cyclo-, iso- and n-pentane, hydrofluorocarbons, preferably HFC 245fa, HFC 134a and HFC 365mfc, hydrochlorofluorocarbons, preferably HCFC 141b, oxygen-containing compounds such as methyl formate and dimethoxymethane, or hydrochlorocarbons, preferably dichloromethane and 1,2-dichloroethane. Suitable blowing agents further include ketones (e.g. acetone) or aldehydes (e.g. methylal).

In addition to water and any physical blowing agents, it is also possible to use other chemical blowing agents which react with isocyanates to evolve a gas, examples being formic acid or carbonates.

Suitable flame retardants for the purposes of the present invention are preferably liquid organophosphorus compounds such as halogen-free organophosphates, e.g. triethyl phosphate (TEP), halogenated phosphates, e.g. tris(1-chloro-2-propyl) phosphate (TCPP) and tris(2-chloroethyl) phosphate (TCEP), and organic phosphonates, e.g. dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as expandable graphite and melamine.

The processing of the formulations to give rigid foams can be carried out according to any method known to a person skilled in the art, for example by manual mixing or preferably by means of high pressure foaming machines. Batch processes may be used here, for example in the manufacture of moulded foams, refrigerators and panels, or continuous processes, for example in the case of insulation boards, metal composite elements, slabs or in the case of spraying processes.

By means of the process according to the invention, it is possible to use polyurethane systems, especially polyurethane foams, which have the feature of including at least neodecanoic acid or the tin salt thereof. Preferably, the polyurethane systems according to the invention, more preferably polyurethane foams, comprise essentially (more than 98%, based on the carboxylic acids present or tin salts thereof), preferably exclusively, neodecanoic acid or the tin salts thereof in the form of the carboxylic acid or tin salt thereof.

It is a feature of preferred polyurethane systems according to the invention, especially polyurethane foams, that the proportion by mass of neodecanoic acid or salts thereof is from 0.001% to 5% by mass, based on the weight of the overall foam, preferably from 0.005% to 1.5% by mass.

The polyurethane systems according to the invention may, for example, be polyurethane coatings, polyurethane adhesives, polyurethane sealants, polyurethane elastomers or polyurethane foams, especially a flexible polyurethane foam, a rigid polyurethane foam, a viscoelastic foam, an HR foam, a semirigid polyurethane foam, a thermoformable polyurethane foam or an integral foam. The term polyurethane herein is to be understood as a generic term for any polymer obtained from di- or polyisocyanates and polyols or other isocyanate-reactive species, such as amines for example, in that the urethane bond need not be the only or predominant type of bond. Polyisocyanurates and polyureas are also expressly included.

The polyurethane systems according to the invention, especially the polyurethane foams, preferably the closed-cell polyurethane foams, can be used for example as refrigerator insulation, insulation panel, sandwich element, pipe insulation, spray foam, 1- and 1.5-component can foam, wood imitation, modelling foam, packaging foam, mattresses, furniture cushioning, automotive seat cushioning, headrest, dashboard, automotive interior, automotive roof liner, sound absorption material, steering wheel, shoe sole, carpet backing foam, filter foam, sealing foam, sealant and adhesive. Closed-cell polyurethane foams are understood in the context of the present invention to mean those which have an air permeability or porosity of greater than 30 mm, determined by the method specified in the examples. Particularly preferred polyurethane systems according to the invention, preferably polyurethane foams, are watertight in the sense of the abovementioned definition.

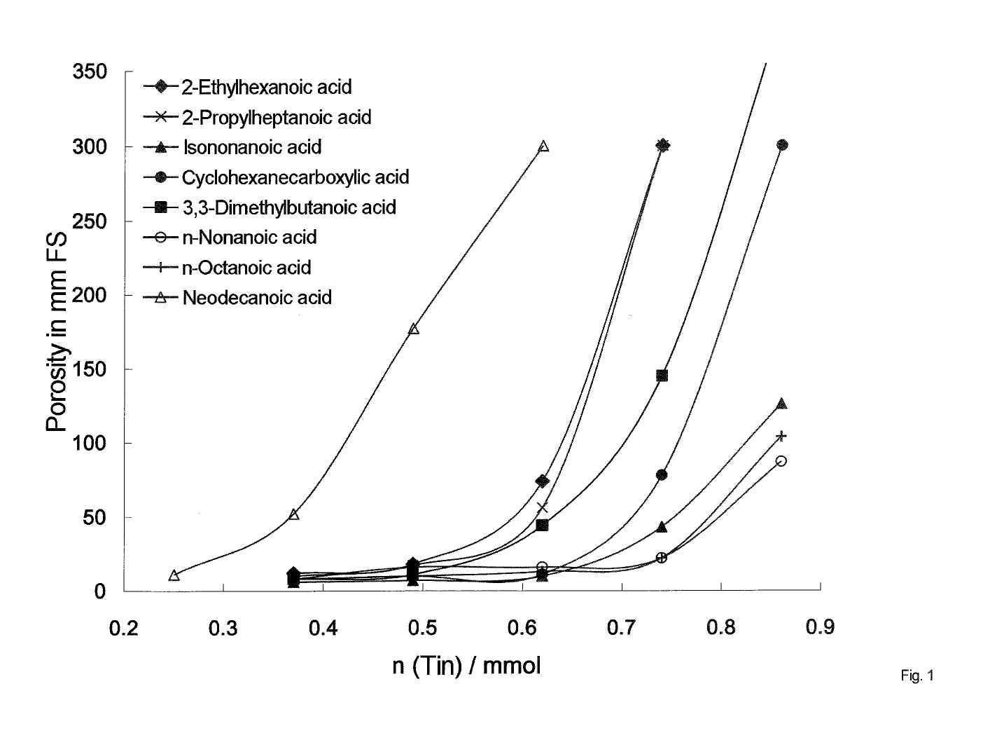

The present invention is elucidated in detail with reference to the figure, FIG. 1, without any intention that the subject-matter of the application be restricted thereto.

FIG. 1 shows a graph with the results of example 41, in which the molar amount of tin in the respective catalyst system in mmol is given on the X axis and the porosity in mm of liquid acid (LA) of the resultant foams on the Y axis.

The present invention is illustratively described in the examples listed below without any intention of limiting the invention, whose scope is determined by the entire description and the claims, to the embodiments referred to in the examples.

### EXAMPLES

### Examples 1 to 41

### Production of Polyurethane Foams

For production of the polyurethane foams, the following formulation was used: 100 parts by weight of polyetherol (hydroxyl number=47 mg KOH/g, 11-12% EO), 4 parts by weight of water, 1 part by weight of TEGOSTAB® BF 2370 (silicone stabilizer from Evonik Industries AG), 0.1 part by weight of a tertiary amine (TEGOAM IN® 33 (amine catalyst, Evonik Industries AG), 50.6 parts by weight of T 80 toluene diisocyanate (index 110), and a variable amount of KOSMOS® 29 (tin octoate, Evonik Industries AG) or of the tin carboxylates to be examined. Noninventive compounds selected for comparison were molecules having a substantial structural relationship with tin neodecanoate (tin salt of neodecanoic acid) in the form of 2-ethylhexanoic acid, 2-ethylbutyric acid, 2-propylheptanoic acid and 3,5,5-trimethylheptanoic acid.

In the foaming operation, 400 g of polyol were used; the other formulation constituents were adjusted correspondingly. Table 1 summarizes the variable constituents of the formulations of example foams 1 to 35.

To effect foaming, the polyol, water, amine, tin catalyst and silicone stabilizer were thoroughly mixed under agitation. After the isocyanate had been added, the mixture was stirred at 3000 rpm with a stirrer for 7 sec. The resultant mixture was poured into a paper-lined wooden box (base area 27 cm×27 cm). The result was a foamed material which was subjected to the performance tests described hereinbelow.

TABLE 1
Variable constituents of the formulations for example foams 1 to 41.

| Example no. | inventive | Salt^{[1]} | Catalyst [pts. by wt.] |
|---|---|---|---|
| 1 | no | a) | 0.15 |
| 2 | no | a) | 0.20 |
| 3 | no | a) | 0.25 |
| 4 | no | a) | 0.30 |
| 5 | no | a) | 0.35 |
| 6 | no | b) | 0.17 |
| 7 | no | b) | 0.23 |
| 8 | no | b) | 0.285 |
| 9 | no | b) | 0.34 |
| 10 | no | b) | 0.40 |
| 11 | no | c) | 0.16 |
| 12 | no | c) | 0.215 |
| 13 | no | c) | 0.27 |
| 14 | no | c) | 0.33 |
| 15 | no | c) | 0.38 |
| 16 | no | d) | 0.30 |
| 17 | no | d) | 0.40 |
| 18 | no | d) | 0.50 |
| 19 | no | d) | 0.60 |
| 20 | no | d) | 0.70 |
| 21 | no | e) | 0.137 |
| 22 | no | e) | 0.18 |
| 23 | no | e) | 0.228 |
| 24 | no | e) | 0.274 |
| 25 | no | e) | 0.32 |
| 26 | no | f) | 0.128 |
| 27 | no | f) | 0.17 |
| 28 | no | f) | 0.213 |
| 29 | no | f) | 0.256 |
| 30 | no | f) | 0.299 |
| 31 | no | g) | 0.16 |
| 32 | no | g) | 0.21 |
| 33 | no | g) | 0.267 |
| 34 | no | g) | 0.32 |
| 35 | no | g) | 0.374 |
| 36 | yes | h) | 0.113 |
| 37 | yes | h) | 0.17 |
| 38 | yes | h) | 0.228 |
| 39 | yes | h) | 0.285 |
| 40 | yes | h) | 0.34 |
| 41 | yes | h) | 0.398 |

^{[1]}a) = tin(II) salt of 2-ethylhexanoic acid b) = tin(II) salt of 2-propylheptanoic acid c) = tin(II) salt of isononanoic acid d) = tin(II) salt of n-octanoic acid (50% by weight, blended in DPG) e) = tin(II) salt of cyclohexanecarboxylic acid f) = tin(II) salt of 3,3-dimethylbutanoic acid g) = tin(II) salt of n-nonanoic acid h) = tin(II) salt of neodecanoic acid

Physical Properties of the Foams:

The foams produced were assessed on the basis of the following physical properties:

a) Foam settling after the end of the rise phase (=fall-back):
The fall-back, or the further rise, is found from the difference in the foam height after direct blow-off and after 3 minutes after foam blow-off. The foam height is measured at the maximum in the middle of the foam crest by means of a needle secured to a centimetre scale.

b) Foam height:
The final height of the foam is determined by subtracting the settling from or adding the post-rise to the foam height after blow-off.

c) Foam density (FD):
Determined as described in ASTM D 3574-08 under Test A by measuring the core density.

d) Air permeability/porosity

e) Compression load deflection CLD, 40%

f) Compression set on compression by 90% at 70° C. for 22 h

g) Resilience (ball rebound test)

Tests e) to g) were conducted to ASTM D 1564-71.

Test d) was conducted as follows:

Method:

The air permeability/porosity of the foam was determined by a dynamic pressure measurement on the foam. The dynamic pressure measured was reported in mm alcohol column, with the lower dynamic pressure values characterizing the more open foam. The values were measured in the range from 0 to 300 mm.

Apparatus:

The measurement apparatus was fed by the in-house nitrogen supply and is therefore connected thereto, and consists of the following parts connected to one another

reducing valve with manometer,

flow-regulating screw,

wash bottle,

flowmeter,

T-piece,

nozzle head,

scaled glass bottle, filled with alcohol.

The wash bottle is obligatory only when the apparatus is fed not from the internal supply but directly with technical-grade bottled gas.

The flowmeter should be calibrated prior to the first operation according to the manufacturer's instructions using the calibration curve supplied, and should be marked at 8 l/min=480 l/h.

The nozzle head is specified by an edge length of 100×100 mm, a weight between 800 and 1000 g, a clear width of the outflow orifice of 5 mm, and a clear width of the lower head ring of 30 mm.

The measurement fluid (technical grade alcohol (ethanol)) can be coloured to raise the optical contrast.

Measurement Operation:

The nitrogen supply pressure was adjusted to 1 bar by a reducing valve. The flow rate was regulated to the corresponding 480 Vh by the flow-regulating screw. The amount of liquid in the scaled glass tube was brought to a level with alcohol, such that no pressure differential has been built up or can be read off. For the actual analysis of the test specimen, five individual measurements were conducted, four at the four corners and one in the middle of the test specimen. For this purpose, the nozzle head is laid on congruent with the edges; the middle of the test specimen is estimated. The dynamic pressure is read off once a constant dynamic pressure has been achieved.

Evaluation:

The upper measurement limit of the method is at 300 mm liquid column (LC). For the reporting, a distinction is made between the different cases:
1. All five values are below 300 mm LC. In this case, the arithmetic mean is formed and reported.
2. All five values are greater than or equal to 300 mm LC. In this case, the value of>300 or 300 should be reported.
3. For the five measurements, a) values can be determined explicitly, b) values are greater than or equal to 300: the arithmetic mean is formed from five values, using 300 for each of the b) measurements. The number of values greater than or equal to 300 is likewise reported separately from the mean with an oblique stroke.
Example:
Four measurements corresponding to 180, 210, 118 and 200 mm LC; one measurement>300 mm LC gives (180+210+118+200+300)/5. Report entry: 202/1.

The results are summarized in Table 2.

TABLE 2
Results of the determination of the physical properties

| Ex. | Rise time | Fall-back | Height | Density | Porosity | CLD 40% | Compression | Rebound |
|---|---|---|---|---|---|---|---|---|
| no. | [s] | [cm] | [cm] | [kg/m³] | [mm] | [kPa] | set | [cm] |
| 1 | 112 | −0.2 | 31.8 | 24.6 | 9 | 4.5 | 6 | 39 |
| 2 | 99 | −0.2 | 33.4 | 23.9 | 33 | 5.2 | 9 | 42 |
| 3 | 92 | +0.5 | 34.1 | 23.2 | 201 | 5.9 | 34 | 44 |
| 4 | 84 | +1.2 | 35.3 | 25.8 | 300 | 7.1 | 72 | 42 |
| 5 | 80 | +1.7 | 36.2 | shrinks | — | — | — | — |
| 6 | 119 | +0.1 | 30.1 | 24.9 | 10 | 4.0 | 5 | 41 |
| 7 | 104 | −0.2 | 30.9 | 25.0 | 17 | 4.5 | 8 | 41 |
| 8 | 95 | −0.1 | 32.0 | 24.3 | 56 | 4.9 | 12 | 44 |
| 9 | 90 | +0.4 | 32.7 | 23.0 | 300 | 5.3 | 74 | 41 |
| 10 | 86 | +0.8 | — | shrinks | — | — | — | — |
| 11 | 131 | +0.2 | 30.4 | 24.7 | 6 | 3.6 | 5 | 43 |
| 12 | 111 | ±0.0 | 30.6 | 24.7 | 7 | 4.0 | 5 | 42 |
| 13 | 100 | −0.1 | 31.2 | 24.7 | 10 | 4.4 | 6 | 41 |
| 14 | 90 | ±0.0 | 32.1 | 24.3 | 43 | 4.9 | 9 | 40 |
| 15 | 85 | +0.3 | 32.8 | 23.6 | 126 | 5.2 | 70 | 36 |
| 16 | 126 | +1.1 | 30.3 | 24.1 | 8 | 3.5 | 5 | 46 |
| 17 | 107 | −0.1 | 31.1 | 24.5 | 10 | 3.8 | 4 | 44 |
| 18 | 95 | −0.1 | 31.6 | 24.6 | 13 | 4.2 | 4 | 42 |
| 19 | 87 | −0.1 | 32.4 | 24.3 | 22 | 4.7 | 6 | 37 |
| 20 | 80 | +0.1 | 32.7 | 24.0 | 104 | 5.0 | 7 | 40 |
| 21 | 120 | +0.1 | 30.6 | 24.6 | 8 | 3.6 | 4 | 43 |
| 22 | 104 | −0.1 | 31.1 | 24.6 | 10 | 4.0 | 5 | 42 |
| 23 | 92 | −0.2 | 31.8 | 24.6 | 11 | 4.6 | 6 | 42 |
| 24 | 85 | ±0.0 | 32.6 | 24.0 | 78 | 5.1 | 9 | 42 |
| 25 | 82 | +0.6 | 33.5 | 22.8 | 300 | 5.6 | 81 | 46 |
| 26 | 111 | ±0.0 | 30.8 | 24.7 | 8 | 3.9 | 4 | 43 |
| 27 | 95 | −0.2 | 31.8 | 24.7 | 11 | 4.3 | 5 | 42 |
| 28 | 86 | −0.2 | 32.7 | 24.2 | 44 | 4.8 | 7 | 32 |
| 29 | 79 | +0.2 | 33.6 | 23.3 | 145 | 5.2 | 61 | 41 |
| 30 | 80 | +0.6 | — | shrinks | — | — | — | — |
| 31 | 131 | +0.2 | 31.0 | 26.1 | 8 | 2.9 | 6 | 43 |
| 32 | 115 | +1.3 | 31.2 | 23.4 | 16 | 2.8 | 6 | 41 |
| 33 | 100 | −0.1 | 31.4 | 24.3 | 16 | 3.2 | 6 | 41 |
| 34 | 88 | −0.2 | 31.8 | 24.4 | 22 | 3.4 | 8 | 41 |
| 35 | 77 | +0.1 | 32.4 | 23.9 | 87 | 3.8 | 25 | 37 |
| 36 | 117 | 0 | 29.7 | 25.6 | 11 | 3.2 | 7 | 41 |
| 37 | 112 | +0.1 | 30.4 | 24.9 | 52 | 3.4 | 14 | 37 |
| 38 | 96 | +0.3 | 31.3 | 24.0 | 177 | 4.0 | 81 | 21 |
| 39 | 93 | +0.7 | 33.0 | 22.6 | 300 | 4.6 | 83 | 23 |
| 40 | 93 | +1.1 | 34.4 | 22.5 | 300 | 6.1 | 80 | 29 |
| 41 | 85 | +1.2 | 35.1 | shrinks | — | — | — | — |

The parts by weight of the respective catalysts were calculated in such a way that the tin content is equimolar in the systems to be compared. The open-cell content of the foams, when the use amount of tin isononanoate, for example, is increased, decreases only from 6 to 126 mm dynamic pressure water column, and in the case of n-octanoic acid, only from 8 to 104 mm. In comparison, significantly smaller amounts of tin neodecanoate already lead to very closed-cell foams (examples 37 to 40: mm>50).

### Examples 42 to 56

### Production of Polyurethane Foams

The formulation and procedure have been undertaken analogously to Examples 1-41.

For production of the polyurethane foams, the following formulation was used: 100 parts by weight of polyetherol (hydroxyl number=47 mg KOH/g, 11-12% EO), 4 parts by weight of water, 1 part by weight of TEGOSTAB® BF 2370 (silicone stabilizer from Evonik Industries AG), 0.10 part by weight of a tertiary amine, 50.6 parts by weight of T 80 toluene diisocyanate (index 110), and a variable amount of KOSMOS® 29 (tin octoate, Evonik Industries AG) or of the tin carboxylates to be examined. Noninventive compounds selected for comparison were molecules having a substantial structural relationship with tin neodecanoate (tin salt of neodecanoic acid) and blends of tin neodecanoate (in various organic solvents) in the form of 2-ethylhexanoic acid and 3,5,5-trimethylheptanoic acid.

In the foaming operation, 400 g of polyol were used; the other formulation constituents were adjusted correspondingly. Table 3 summarizes the variable constituents of the formulations of example foams 42 to 56.

To effect foaming, the polyol, water, amine, tin catalyst and silicone stabilizer were thoroughly mixed under agitation. After the isocyanate had been added, the mixture was stirred at 2500 rpm for another 7 sec. The resultant mixture was poured into a paper-lined wooden box (base area 27 cm×27 cm). The result was a foamed material which was subjected to the performance tests described hereinbelow or above.

TABLE 3
Variable constituents of the formulations for example
foams 42 to 55.

| Example no. | inventive | Salt^{[1]} | Catalyst [pts. by wt.] |
|---|---|---|---|
| 42 | no | a) | 0.20 |
| 43 | no | b) | 0.20 |
| 44 | no | b) | 0.215 |
| 45 | no | b) | 0.30 |
| 46 | yes | c) | 0.20 |
| 47 | yes | c) | 0.228 |
| 48 | yes | d) | 0.20 |
| 49 | yes | d) | 0.228 |
| 50 | yes | d) | 0.25 |
| 51 | yes | d) | 0.28 |
| 52 | yes | e) | 0.20 |
| 53 | yes | e) | 0.228 |
| 54 | yes | e) | 0.25 |
| 55 | yes | e) | 0.28 |

^{[1]}a) = tin(II) salt of 2-ethylhexanoic acid b) = tin(II) salt of isononanoic acid c) = tin(II) salt of neodecanoic acid d) = tin(II) salt of neodecanoic acid (80% by weight, blended in isopropyl myristate) e) = tin(II) salt of neodecanoic acid (80% by weight, blended in dipropylene glycol (DPG))

Physical Properties of the Foams:

The foams produced were assessed in terms of their physical properties analogously to example foams 1-41. The results are summarized in Table 4.

TABLE 4
Results of the determination of the physical properties

| Ex. | Rise time | Fall-back | Height | Density | Porosity | CLD 40% | Compression | Rebound |
|---|---|---|---|---|---|---|---|---|
| no. | [s] | [cm] | [cm] | [kg/m³] | [mm] | [kPa] | set | [cm] |
| 42 | 99 | −0.10 | 30.8 | 24.90 | 12 | 4.2 | 24 | 44 |
| 43 | 161 | +2.70 | 32.0 | n.d. | 8 | n.d. | n.d. | n.d. |
| 44 | 118 | +0.30 | 29.9 | 24.40 | 6 | 3.7 | 6 | 45 |
| 45 | 151 | −0.20 | 30.2 | 24.30 | 8 | 3.5 | 6 | 47 |
| 46 | 106 | +0.30 | 30.2 | 24.80 | 98 | 4.6 | 77 | 27 |
| 47 | 101 | +0.20 | 31.5 | 23.70 | 185 | 4.6 | 79 | 36 |
| 48 | 115 | +0.10 | 30.4 | 24.10 | 27 | 3.9 | 26 | 43 |
| 49 | 108 | ±0.0 | 30.8 | 24.90 | 106 | 4.6 | 73 | 37 |
| 50 | 104 | ±0.0 | 30.4 | 24.40 | 97 | 4.5 | 75 | 33 |
| 51 | 100 | +0.20 | 32.0 | 23.90 | 199 | 4.7 | 77 | 38 |
| 52 | 116 | −0.10 | 29.7 | 24.80 | 18 | 3.9 | 47 | 45 |
| 53 | 109 | ±0.0 | 31.1 | 25.00 | 46 | 4.5 | 72 | 41 |
| 54 | 109 | +0.10 | 30.9 | 24.90 | 227 | 4.8 | 71 | 32 |
| 55 | 103 | +0.20 | 31.2 | 23.80 | 196 | 4.6 | 80 | 40 |

### Examples 56 to 66

### Production of Polyurethane Foams

For production of the polyurethane foams, the following formulation was used: 100 parts by weight of polyetherol (hydroxyl number=47 mg KOH/g, 11-12% EO), 4 parts by weight of water, 2.50 parts by weight of dichloromethane, 1 part by weight of TEGOSTAB® BF 2370 (silicone stabilizer from Evonik Industries AG), 0.12 part by weight of a tertiary amine, 52.5 parts by weight of T 80 toluene diisocyanate (index 112), and a variable amount of KOSMOS® 29 (tin octoate, Evonik Industries AG) or of the tin carboxylates to be examined. Noninventive compounds selected for comparison were molecules having a substantial structural relationship with tin neodecanoate (tin salt of neodecanoic acid) and blends of tin neodecanoate (in organic solvents) in the form of 2-ethylhexanoic acid and 3,5,5-trimethylheptanoic acid.

In the foaming operation, 400 g of polyol were used; the other formulation constituents were adjusted correspondingly. Table 5 summarizes the variable constituents of the formulations of example foams 56 to 66.

To effect foaming, the polyol, water, amine, tin catalyst and silicone stabilizer were thoroughly mixed under agitation. The dichloromethane was added and the mixture was stirred at 1000 rpm with a stirrer for 15 sec. After the isocyanate had been added, the mixture was stirred at 2500 rpm for another 7 sec. The resultant mixture was poured into a paper-lined wooden box (base area 27 cm×27 cm). The result was a foamed material which was subjected to the performance tests described hereinbelow.

TABLE 5
Variable constituents of the formulations for example
foams 56 to 66.

| Example no. | Inventive | Salt^{[1]} | Catalyst [pts. by wt.] |
|---|---|---|---|
| 56 | no | a) | 0.20 |
| 57 | no | b) | 0.20 |
| 58 | no | b) | 0.23 |
| 59 | yes | c) | 0.20 |
| 60 | yes | c) | 0.22 |
| 61 | yes | d) | 0.30 |
| 62 | yes | e) | 0.20 |
| 63 | yes | e) | 0.24 |
| 64 | yes | f) | 0.20 (0.20 TA DMEA) |
| 65 | yes | f) | 0.20 (0.30 TA DMEA) |
| 66 | yes | f) | 0.20 (0.20 TA DMEA/0.04 BDE100) |

^{[1]}a) = tin(II) salt of 2-ethylhexanoic acid b) = tin(II) salt of isononanoic acid c) = tin(II) salt of neodecanoic acid d) = tin(II) salt of neodecanoic acid (75% by weight, blended in isopropyl myristate) e) = tin(II) salt of neodecanoic acid (80% by weight, blended in isopropyl myristate) f) = tin(II) salt of neodecanoic acid (80% by weight, blended in dipropylene glycol (DPG))
TA DMEA = TEGOAMIN ® DMEA (N,N-dimethylethanolamine)

Physical Properties of the Foams:

The foams produced were assessed in terms of their physical properties analogously to example foams 1-41. The results are summarized in Table 6.

TABLE 6
Results of the determination of the physical properties

| | | | | | | CLD | |
|---|---|---|---|---|---|---|---|
| Ex. | Rise | Fall-back | Height | Density | Porosity | 40% | Rebound |
| no. | time [s] | [cm] | [cm] | [kg/m³] | [mm] | [kPa] | [cm] |
| 56 | 97 | −0.15 | 34.01 | 22.42 | 14 | 3.6 | 41 |
| 57 | 105 | −0.63 | 34.82 | 22.84 | 7 | 3.2 | 45 |
| 58 | 104 | −0.60 | 35.03 | 22.22 | 11 | 3.5 | 42 |
| 59 | 98 | −0.25 | 34.86 | 22.82 | 41 | 3.6 | 36 |
| 60 | 92 | −0.10 | 35.05 | 22.86 | 97 | 3.9 | 21 |
| 61 | 99 | −0.10 | 33.80 | 22.30 | 56 | 3.7 | 30 |
| 62 | 107 | −0.27 | 34.50 | 22.8 | 10 | 3.1 | 41 |
| 63 | 96 | −0.20 | 34.56 | 22.2 | 11 | 3.5 | 41 |
| 64 | 122 | −0.21 | 34.37 | 22.0 | 12 | 3.0 | 44 |
| 65 | 113 | −0.21 | 34.61 | 22.6 | 10 | 3.3 | 43 |
| 66 | 102 | −0.67 | 34.55 | 22.2 | 12 | 3.0 | 43 |

A comparison of Example 56 (tin octoate) with Examples 59 and 60 (pure tin neodecanoate) and Example 63 (4:1 blend) shows that the tin octoate gives an open foam, whereas pure tin neodecanoate gives a closed foam with a similar rise time, even though the effective amount of tin in the catalyst is lower compared to the octoate. Blending of the neodecanoate (4:1) achieves a comparable rise time to that for tin octoate. It is also apparent that, compared to Examples 59 and 60 (pure), the open-cell content of the foam is improved, with simultaneous lowering of the effective amount of tin.

Determination of Emissions

Acid emission is determined on the basis of the Mercedes-Benz test method PB VWT 709.

There follows a description of the procedure for the thermal desorption with subsequent gas chromatography-mass spectrometry coupling (GC-MS).

a) Measurement Technique:
The thermal desorption is conducted with a “TDS2” thermal desorber with autosampler from Gerstel, Mülheim, in conjunction with a Hewlett Packard HP6890/HP5973 GC/MSD system.

b) Measurement Conditions:

| | |
|---|---|
| Thermal desorption | Gerstel TDS 2 |
| Desorption temperature | 90° C. |
| Desorption time | 30 min |
| Flow rate | 60 ml/min |
| Transfer line | 280° C. |
| Cryofocusing | HP 6890 PTV |
| Liner | Glass vaporizer tube with silanized glass wool |
| Temperature | −150° C. |
| GC | Capillary GC HP 6890 |
| Injector | PTV Split 1:50 |
| Temperature programme | −150° C.; 3 min; [symbol] 720° C./min; 280° C. |
| Column | 60 m * 0.25 mm Optima 5 MS FT 0.5 μm |
| Flow rate | 1 ml/min const. flow |
| Temperature programme | 50° C.; 5 min; [symbol] 3° C./min; 92° C.; |
| | [symbol] 5° C./min; 160° C.; |
| | [symbol] 10° C./min; 280° C.; 20 min |
| Detector | HP MSD 5973 |
| Mode: | Scan 29-350 amu 2.3 scans/sec |
| Evaluation | Evaluation of the total ion flow chromatogram |
| | Calculation of the 2-ethylhexanoic peak as |
| | toluene equivalent |

c) Calibration
For calibration, 1 μl of a mixture of toluene and hexadecane in pentane (0.6 mg/ml of each) is introduced into a cleaned adsorption tube filled with Tenax TA (mesh 35/60) and analysed (desorption 5 min; 280° C.).

d) Sample Preparation
10 mg of foam in three partial samples are pushed into a thermal desorption tube. In doing so, it is ensured that the foam is not compressed.

e) Evaluation
To quantify the acid emission, the peak which is recognized as, for example, 2-ethylhexanoic acid by means of the mass spectrum is determined via the peak area thereof with the response factor for toluene from the calibration as ppm of toluene equivalents.

Table 7 summarizes the results of the acid emissions for selected examples.

TABLE 7
Results of the emission determinations

| | | | | Total | Acid | Proportion of |
|---|---|---|---|---|---|---|
| | | | Tin catalyst | emission | emission | total |
| No. | inventive | Acid | [parts] | [μg/g] | [μg/g] | emission [%] |
| 2 | no | 2-ethylhexanoic | 0.2 | 830 | 613 | 74 |
| 12 | no | isononanoic | 0.215 | 770 | 512 | 66 |
| 7 | no | 2-propylheptanoic | 0.23 | 1190 | 805 | 68 |
| 17^{[2]} | no | n-octanoic | 0.2 | 500 | 202 | 40 |
| 32 | no | n-nonanoic | 0.215 | 380 | 119 | 31 |
| 37 | yes | neodecanoic | 0.228 | 690 | 400 | 58 |

^{[2]}without blending in DPG

It is clearly apparent from the results that the emission is distinctly reduced through use of acids having no 2-ethyl or 2-propyl branch, for example neodecanoic acid, isononanoic acid, n-octanoic acid or n-nonanoic acid.

Determination of the Influence of Catalyst Content (Tin Content) on the Porosity of the Foams

Foams were produced as specified in Examples 1 to 41, with variation of the concentration of catalyst system. The foams were produced using tin salts of 2-ethylhexanoic acid, 3,3-dimethylbutyric acid, 2-propylheptanoic acid, cyclohexanecarboxylic acid, isononanoic acid, neodecanoic acid, n-nonanoic acid and n-octanoic acid. The foams obtained were examined in respect of their porosity. The results of these examinations are shown in FIG. 1.

It is readily apparent that, especially in the case of use of catalyst systems based on n-octanoic acid salt and isononanoic acid salt, a reduction in porosity is observed only at distinctly higher concentrations. The corresponding catalyst systems therefore require distinctly higher use amounts compared to tin neodecanoate salts, both in the production of open-cell and of closed-cell foams. While at least 0.37 mmol of the tin catalyst has to be used for tin(II) 2-ethylhexanoate salts in the formulation as used above in order to obtain an open-cell foam, the concentration can be reduced by 32% to 0.25 mmol in the case of use of a tin(II) neodecanoate. Thus, in the case of use of the inventive tin neodecanoate, a distinct reduction in the tin catalyst required is possible, by means of which polyurethane systems, especially polyurethane foams, having a lower tin content are obtainable.

Determination of Water Permeability

The water permeability/watertightness was determined on the basis of the GM test method (General Motors Engineering Standard GM 6086M), as specified in U.S. Pat. No. 6,747,068 B2, example 61 B.

Table 8 gives the formulations of the foams used in the test and the results for the water permeability.

TABLE 8
Results of water permeability determination

| | No. | | | | | |
|---|---|---|---|---|---|---|
| | 42 | 43 | 44 | 45 | 46 | 47 |
| | [pphp] | [pphp] | [pphp] | [pphp] | [pphp] | [pphp] |
| Polyol^{[1]} | 100 | 100 | 100 | 100 | 100 | 100 |
| B 8870 | 2 | 2 | 2 | 2 | 2 | 2 |
| Water | 3 | 3 | 3 | 3 | 3 | 3 |
| TA 33^{[2]} | 0.2 | 0.2 | 0.2 | 0.2 | 0.2 | 0.2 |
| K 29^{[3]} | 0.09 | 0.11 | 0.11 | — | — | — |
| Tin | — | — | — | 0.09 | 0.11 | 0.11 |
| neodecanoate | | | | | | |
| TDI | 39.6 | 39.6 | 39.6 | 39.6 | 39.6 | 39.6 |
| Index | 105 | 105 | 105 | 105 | 105 | 105 |
| Porosity | 3 | 15 | 14 | 12 | 31 | 38 |
| [mm column] | | | | | | |
| Water level | 25 | 25 | 76 | 25 | 25 | 25 |
| [cm] | | | | | | |
| Penetration | 73 | 97 | 46 | 94 | 120 | 93 |
| time [min] | | | | | | |
| Pass | no | yes | no | yes | yes | yes |

^{[1]}Polyether triol of OH number 56, M_{w} = 3100 g/mol, EO/PO based
^{[2]}TEGOSTAB ® B8870 (silicone stabilizer from Evonik Industries AG for production of hydrophobic foams)
^{[3]}TEGOAMIN ® 33 (amine catalyst, Evonik Industries AG)
^{[4]}KOSMOS ® 29 (tin octoate, Evonik Industries AG)

It can be inferred from Table 8 that the foams which have been produced with the aid of tin neodecanoate have a higher level of closed cells, and this enabled production of impervious foams which were optimized in terms of water permeability and passed the GM test without any problem. In addition, given the same use amount of catalyst, it is possible to reduce the amount of tin, since tin neodecanoate is more catalytically active than tin octoate in spite of a lower tin content

1. A catalyst system for use in polyurethane systems, wherein said catalyst system comprises a tin salt of neodecanoic acid.

2. The catalyst system according to claim 1, wherein said catalyst system consists essentially of said tin salt of neodecanoic acid and does not contain any further tin salts or compounds.

3. The catalyst system according to claim 1, further comprising one or more organic solvents.

4. A process for producing polyurethane systems, comprising:
adding said catalyst system according to claim 1 to a reaction mixture comprising one or more organic isocyanates having two or more isocyanate-reactive groups and one or more polyols having two or more isocyante-reactive groups.

5. The process according to claim 4, wherein said catalyst system is added as an anhydrous solution.

6. The process according to claim 4, wherein said catalyst system is added to the reaction mixture before or during a reaction between said one or more organic isocyanates and said one or more poloyls.

7. The process according to claim 4, wherein the amount of tin neodecanoate is from 0.04 to 1 pphp.

8. A polyurethane system, comprising a neodecanoic acid or the salt of neodecanoic acid.

9. A polyurethane system comprising a neodecanoic acid or the salt of neodecanoic acid wherein said system is obtainable or has been obtained by the process according to claim 4.

10. The polyurethane system according to claim 8, wherein the carboxylic acid consists essentially of neodecanoic acid or salts thereof.

11. The polyurethane system according to claim 8, wherein the proportion by mass of neodecanoic acid tin salts is from 0.001% to 2% by mass 0.001% to 5% by mass.

12. The polyurethane system according to claim 8, wherein the polyurethane system is a polyurethane coating, a polyurethane adhesive, a polyurethane sealant, a polyurethane elastomer, a rigid polyurethane foam, a flexible polyurethane foam, a viscoelastic foam, an HR foam, a semi-rigid polyurethane foam, a thermoformable polyurethane foam or an integral foam.

13. (canceled)

14. The process according to claim 4, wherein the amount of tin neodecanoate is from 0.08 to 0.9 pphp.

15. The process according to claim 4, wherein the amount of tin neodecanoate is from 0.09 to 0.7 pphp.
